(19) United States
(12) Patent Application Publication
(10) Pub. No.: US 2024/0399565 A1
(43) Pub. Date: Dec. 5, 2024

(54) PULLEY-INTEGRATED CABLE ACTUATOR AND OPERATION METHOD THEREOF

(71) Applicant: CHUNG ANG UNIVERSITY INDUSTRY ACADEMIC COOPERATION FOUNDATION, Seoul (KR)

(72) Inventors: Gi-uk LEE, Gwangmyeong-si Gyeonggi-do (KR); Jae-ha YANG, Seoul (KR); Jae-wook RYU, Seoul (KR); Jun-young MOON, Seoul (KR)

(21) Appl. No.: 18/804,446

(22) Filed: Aug. 14, 2024

Related U.S. Application Data
(63) Continuation of application No. PCT/KR2022/006065, filed on Apr. 28, 2022.

(30) Foreign Application Priority Data
Mar. 29, 2022 (KR) 10-2022-0038875

(51) Int. Cl. B25J 9/10; B25J 9/00; B25J 13/08

(52) U.S. Cl. CPC B25J 9/1045; B25J 9/0006; B25J 9/1035; B25J 13/088

(57) ABSTRACT

The present disclosure relates to a pulley-integrated cable actuator and an operation method thereof, more particularly to an actuator for operating cables. The pulley-integrated cable actuator includes: a base motor; a sun gear shaft of which the lower end portion is coupled to the center of the base motor, rotating by the motor rotation, and provided with a sun gear; a planet gear set consisting of multiple planet gears that mesh with the sun gear; and a ring gear-integrated pulley where a ring gear is formed on the inner side, meshing with the planet gear, and a pulley for winding a cable is formed on the outer side. The sun gear meshes with the inner space of the planet gear set. The ring gear is integrated with the pulley. The planet gear set is placed inside the pulley, minimizing the volume.

### BACKGROUND

### Technical Field

The present disclosure relates to a pulley-integrated cable actuator and an operation method thereof.

### Related Art

Various forms of wearable robots are being developed to enhance human physical abilities. Until the mid-2010s, wearable robots were operated by electromechanical components, such as motors, to provide users with strong assistive force. These robots fall under exoskeletal category. To operate heavy frames while providing strong assistive force, robots require a high-performance operating system. The exoskeleton's bulky size and weight, caused by its rigid frame and large actuators, make it inconvenience for users to use on a daily basis.

To overcome the limitations of exoskeleton-type robots, researchers at Harvard University and other institutions have proposed the concept of exosuits. These robots are designed with a focus on being light and comfortable to wear. Harvard Exosuit (HE) is constructed from textile materials, minimizing constraints on natural movement. This also reduced the device weight, minimizing inconvenience caused by its momentum when moved. By utilizing Bowden cables to transmit assistive force, this device features an operating system that can be flexed to conform to the user's posture. Due to these advantages, studies have shown that the portable HE version can reduce the energy expenditure of walking and running by 9.3% and 4%, respectively.

Exosuit-type wearable robots have several advantages over exoskeleton-type robots, but still have limitations in terms of size and control performance. Considering the state-of-the art exosuit, HE, the design is still heavy and bulky because the system is not customized to work in harmony with the robot. Two commercial motors with a long cylindrical shape and flat disc-shaped pulley for driving Bowden cables were used in the operating system. The resulting operating system protruded up to 7 cm from the wearer's back, as shown in FIGS. 1 and 2, which was quiet bulky. This design necessitates the use of assistive devices while wearing the exosuit, which can act as obstacles. Additionally, soft wearable robots tend to have lower tracking performance compared to rigid exoskeletons. The soft nature of the exosuits cause significant deformation of the suit when forces are applied, leading to considerable response delays during operation.

Recently, QDD (Quasi-Direct Drive) actuators, which are composed of high torque density motors and low gear ratio transmissions, have gained attention as a new solution for designing lightweight and compact mobile robots with high control frequencies. QDD actuators using low gear ratio transmissions are highly responsive and capable of reverse driving due to their low reflected inertia. In addition, the QDD actuator is referred to as ‘pancake actuator’ due to advantages from its cylindrical shape that has a low height and a wide radius.

Due to these characteristics, actuators are actively used in various forms of robots. For example, MIT Cheetah robot utilized high torque density for shock absorption and high-bandwidth physical interaction by using QDD actuators. Several exoskeletons utilizing QDD have demonstrated promising results recently. For example, a portable hip exoskeleton based on QDD operation proposed by S. Yu et al. was capable of high reverse driving while achieving high nominal torque and high control bandwidth, and weighted a lightweight 3.4 kg.

In regard to the driving of wearable robots by cable based driving methods, conventional robots are driven by connecting pulleys to general motors to wind cables. Therefore, the system has the drawbacks of being bulky and heavy.

According to Prior Art Patent 1 (SOFT EXOSUIT FOR ASSISTANCE WITH HUMAN MOTION, KR patent application No. 10-2015-7036910), pulleys are connected to a general motor and a cable is driven by the pulley. For this, in addition to the motor, the system requires additional bearings, a case, and other components, which increase the system size and causes significant protrusion from the body, making it inconvenience to use.

According to Prior Art Patent 2 (ASSISTIVE FLEXIBLE SUITS, FLEXIBLE SUIT SYSTEMS, AND METHODS FOR MAKING AND CONTROL THEREOF TO ASSIST HUMAN MOBILITY, KR patent application No. 10-2016-0098354), similar to Prior Art Patent 1, a pulley is connected to a general motor instead of a specialized actuator. This increases the system size and causes protrusion, making inconvenience to use.

In the Prior Art Patent 1 and 2, pulleys are mounted on general motors with non-optimized designs for driving cables in cable-driven systems, leading to significant increases in the systems' volume. Therefore, a pulley-integrated actuator is needed that is designed for cable-driven systems and does not require additional components.

### SUMMARY

### Technical Problem

Therefore, the present disclosure is contrived to solve conventional issues as described above. According to an embodiment of the present disclosure, it aims to provide a pulley-integrated cable actuator and an operation method thereof. A pulley-integrated actuator is designed for the cable drive methods, enabling the creation of wearable robots with smaller volume and lighter weight compared to conventional systems.

According to an embodiment of the present disclosure, it aims to provide a pulley-integrated cable actuator and an operation method thereof. A cable-driven actuator is specifically designed for cable-driven robots and integrates pulleys and bearings which are required for cable drive directly into the motor. This optimized design significantly reduces the system volume compared to conventional cable-driven systems. Using this system, the protrusion of the wearable robot from the body is significantly reduced, enhancing user comfort.

Further, according to an embodiment of the present disclosure, it aims to provide a pulley-integrated cable actuator and an operation method thereof. Compared to conventional cable drive methods in which pulleys are attached to motors, a pulley-integrated cable actuator boasts a significantly smaller volume and lighter weight. When utilized for the creation of wearable roots, this reduces the protrusion and weight of the robot from the body, enhancing user comfort. In addition, this actuator can be applied to other cable drive mechanism rather than wearable robots.

### Technical Solution

A first aspect of the present disclosure may be achieved by, as an actuator for operating cables, a pulley-integrated cable actuator including: a base motor; a sun gear shaft of which the lower end portion is coupled to the center of the base motor, rotating by the motor rotation, and provided with a sun gear; a planet gear set consisting of multiple planet gears that mesh with the sun gear; and a ring gear-integrated pulley where a ring gear is formed on the inner side, meshing with the planet gear, and a pulley for winding a cable is formed on the outer side.

The base motor may an inner ring rotation type of frameless motor, consisting of a stator and a rotor and the sun gear shaft is couple to the center of the rotor.

Further, the planet gear set may be configured so that the sun gear meshes with the inner space formed by meshing of the multiple planet gears, rotating the respective planet gears through the sun gear rotation. Simultaneously, the outer periphery side meshes with a ring gear formed on the inner side of the ring gear-integrated pulley, rotating the ring gear-integrated pulley.

Yet further, the ring gear-integrated pulley may include a hollow portion and a flange portion. A ring gear is formed on the inner side of the hollow portion and a cable fixing groove is provided along the outer periphery of the outer side of the flange portion for winding the cable.

Yet further, the pulley-integrated cable actuator may further include a ring gear bearing inserted into the hollow portion of the ring gear-integrated pulley. Yet further, the base motor, the gear shaft, the planet gear set, the ring gear-integrated pulley and a sun gear shaft bearing may be mounted within the inner space formed by an upper casing, a lower casing and an intermediate casing.

Yet further, the pulley-integrated cable actuator further includes a planet gear fixing portion that fixes each of planet gear shafts to the upper casing.

Yet further, pulley-integrated cable actuator include an encoder provided inside the rotor.

Yet further, the encoder includes a magnetizing ring coupled to the lower surface of the rotor, and a reading head for measuring the rotor rotation speed through the magnetizing ring.

Yet further, the lower casing includes a cable replacement casing that is configured to enable detachment and attachment to facilitate cable replacement.

Yet further, the sun gear meshes with the inner space of the planet gear set, the ring gear is integrated with a pulley, and the planet gear set is placed inside the pulley to minimize the volume.

A second aspect of the present disclosure may be achieved by an operation method of a pulley-integrated cable actuator according to the aforementioned first aspect, including steps of: rotating a rotor of a base motor; rotating a sun gear coupled to a rotor center shaft, rotating each planet gear meshed with the sun gear; and rotating a ring gear-integrated pulley by the planet gear rotation to drive cables wound around the ring gear-integrated pulley.

### Advantageous Effects

According to a pulley-integrated cable actuator and an operation method thereof in accordance with the present disclosure, the pulley-integrated actuator is designed for the cable drive methods, thereby enabling the creation of wearable robots with smaller volume and lighter weight compared to conventional systems.

According to a pulley-integrated cable actuator and an operation method thereof in accordance with the present disclosure, the cable-driven actuator is specifically designed for cable-driven robots and integrates pulleys and bearings which are required for cable drive directly into the motor, thereby significantly reducing the system volume compared to conventional cable-driven systems due to this optimized design. Using this system, the protrusion of the wearable robot from the body is significantly reduced, thereby enhancing user comfort.

Further, according to a pulley-integrated cable actuator and an operation method thereof in accordance with the present disclosure, compared to conventional cable driving methods in which pulleys are attached to motors, the pulley-integrated cable actuator boasts a significantly smaller volume and lighter weight. When utilized for the creation of wearable roots, this reduces the protrusion and weight of the robot from the body, thereby enhancing user comfort. In addition, this actuator is applicable to other cable drive mechanism rather than wearable robots.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The patent or application file contains at least one drawing/photograph executed in color. Copies of this patent or patent application with color drawing(s)/photograph(s) will be provided by the Office upon request and payment of the necessary fec.

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings.

FIG. 1 shows a side view of Harvard Exosuit (HE) protruding approximately 7 cm,

FIG. 2 shows an operating system applied to the exosuit of FIG. 1,

FIG. 3 shows design variables and feasible combinations for comparison (design concept is represented along with a cross-section view, where gray indicates fixed components. Similarly, orange indicates a stator, blue indicates a rotor and the input of the reduction stage, red indicates the output of reduction stage with a pulley, and green indicates a planet gear. A sun gear and a ring gear are the innermost and the outermost gears, respectively. A planet carrier is an intermediate gear between them. Gears are represented by vertical stripes, while bearing are represented by X),

FIG. 4 shows a perspective view of a pulley-integrated cable actuator according to an embodiment of the present disclosure,

FIG. 5 show a cross-sectional view of a pulley-integrated cable actuator according to an embodiment of the present disclosure,

FIG. 6 shows an exploded perspective view of a pulley-integrated cable actuator according to an embodiment of the present disclosure,

FIG. 7 shows the Dynamometer test setup for evaluating the steady-state performance of PEQDD,

FIG. 8 shows an energy efficiency map of PEQDD under the steady-state condition (Areas marked in red indicate operating ranges that fall outside the normal range),

FIG. 9 shows test results of the control bandwidth test between PEQDD and Maxon motor,

FIG. 10 shows a flowchart of the cable replacement according to an embodiment of the present disclosure,

FIGS. 11 and 12 show comparison photos of hip extension exosuit working packages. FIG. 11 shows an exosuit designed by Harvard University and FIG. 12 shows an improved exosuit based on the PEQDD actuator actually fabricated according to an embodiment of the present disclosure,

FIGS. 13 and 14 show the preliminary test results of the PEQDD implemented in hip extension exosuits. FIG. 13 shows a force profile for working state and FIG. 14 shows a force profile for running state.

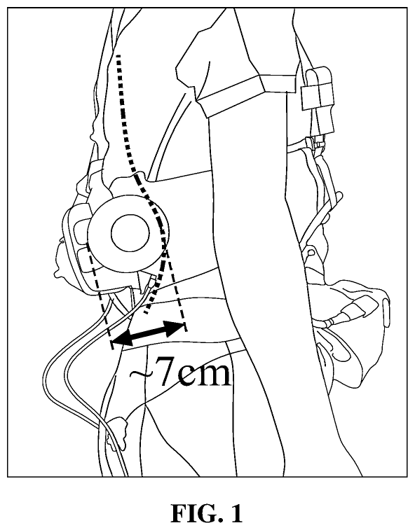

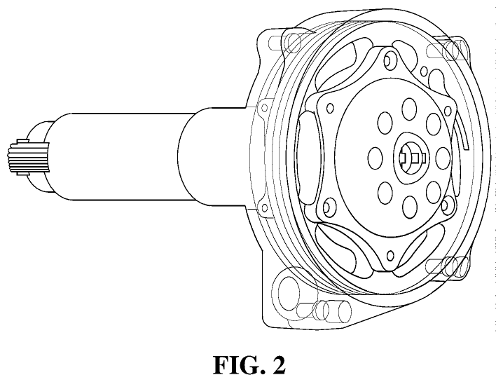

### DETAILED DESCRIPTION

### Best Mode

Hereinafter, described are a pulley-integrated cable actuator and an operation method thereof.

Inventors of the present disclosure have developed a new cable-driven operating device based on QDD to make the exosuit operating system highly responsive while also making it lightweight and compact. To design a custom actuator for an exosuit, the design requirements for the new actuator were first established based on HE specifications. Next, several design concepts were evaluated and compared to select the optimal design for a cable-driven actuator. A lightweight and compact cable-driven actuator was manufactured using components selected based on design constrains or designed through mechanical analysis.

Then, the characteristics of the actuator were analyzed using a dynamometer. As explained later, the control bandwidth of the actuator was measured and showed improved performance compared to the original motor used in HE. Finally, preliminary tests were conducted for walking and running using an exosuit equipped with the actuator proposed in the present disclosure to evaluate the actuator performance in actual use.

First, the design requirements for the new actuator were selected based on HE specifications. The selected parameters were output torque and speed, and actuator weight and volume.

The required torque of the actuator was set based on the maximum assistive force of the HE, designed to apply a force of 300N to the user's body. A 40 mm radius pulley was used in the HE, and ideally more than 12 Km of torque is required in the actuator to generate a force of 300N on the cable. The cable-driven operating system used in the HE employs a Bowden cable placed inside a fixed cable sheath. When the cable is pulled, it slides inside the sheath. The efficiency of the system is reduced due to energy losses caused by friction between the sheath and the cable. The efficiency of the cable-sheath system is determined by the bending angle of the cable sheath, as expressed in the following equation 1.

$${η}_{cable} = exp ( - 0.2 \cdot σ ) \qquad [ Equation 1 ]$$

According to previous experience, the bending angle of a cover rarely exceeds 30 degrees. Therefore, based on Equation 1, the cable efficiency η_{cable} was assumed to be approximately 90%. Considering the 90% efficiency in the 40 mm radius pulley and cable, the required torque of the pulley was set to 13.3 Nm to match the force requirement.

The actuator speed requirements were set based on the motor specifications originally used in the HE. The exosuit utilizes a 200 W BLDC motor (EC-4pole 30, Maxon) and features 51:1 gear reduction (planetary Gearhead GP 32 HP 326664) resulting in a nominal speed of 313 rpm after reduction. The rotation speed of the new actuator pulley was set to at least this speed to allow the new actuator to have the same or wider operating ranges as the original motor.

Since the new actuator is operated as an entire actuation system, the weight and volume requirements for the actuator were set in comparison to the actuation system of the HE. The weight of the operating system for one side of the HE is 753 g and the volume is 270 cm³. To make the system lighter and more compact, the target weight and volume of the actuator were set to 85% of the original operating system values, which were 640 g and 230 cm³, respectively. Since the enclosed space inside the casing cannot be utilized, the volume was measured including the enclosed space of the system.

Another crucial factor in actuator design is the actuator shape. Even if the new actuator has smaller volume compared to the existing system of HE, achieving the same level of extrusion is not meaningful. When designing a new form factor for an exosuit using the new actuator, it was planned to place the actuator so that the flat side of the cylinder would make contact with the wearer's back. The new actuator shape was chosen to be a flat and wide cylinder to maximize the design benefits using a QDD actuator. In this way, the height of the cylinder was a primary cause of extrusion. Considering the HE protruding approximately 7 cm from the body, the goal was to design the new actuator with a height of less 3.5 cm, which is a 50% reduction from the original height. Table 1 shows design requirements set for each parameter.

TABLE 1
Design Requirements for Actuator

| Parameters | Design requirement |
|---|---|
| Pulling force (N) | ≥300 |
| Pulley torque (Nm) | ≥13.3 |
| Pulley speed (RPM) | ≥313 |
| Total weight (g) | ≥640 |
| Enclosed volume (cm³) | ≥230 |
| Height of the actuator (cm) | ≥3.5 |
| Actuator shape | Flat and wide cylinder |

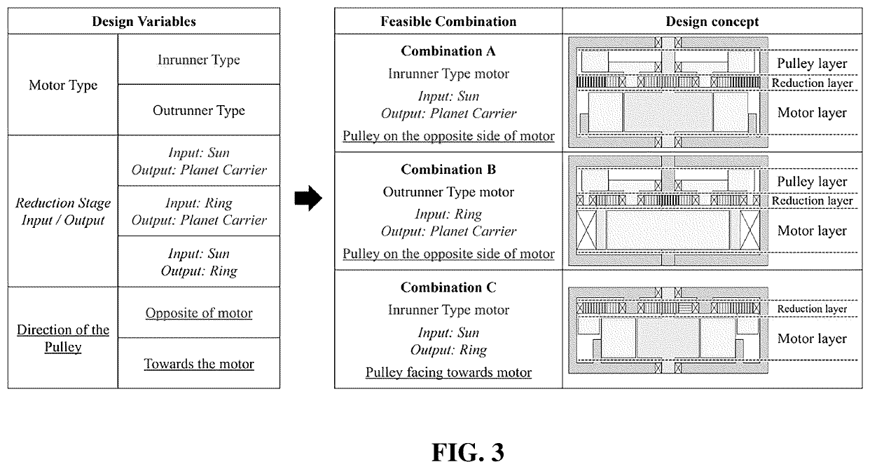

According to an embodiment of the present disclosure, various design concepts of QDD based cable-driven actuators were evaluated to design a new exosuit actuator that maximizes the advantages of QDD type actuators. A design concept was created by altering the type and location of three crucial components. Only designs that could potentially meet requirements while maintaining a flat cylinder shape of the actuator, including the baseline motor, reduction stage and pulley, were considered. Therefore, in the reduction stage, a single stage planet gear set was considered. After exploring feasible design combinations for each component, as shown in FIG. 3, three design concepts were selected and evaluated for comparison to choose the optimal design for the actuator.

FIG. 3 shows design variables and feasible combinations for comparison (design concept is represented along with a cross-section view, where gray indicates fixed components. Similarly, orange indicates a stator, blue indicates a rotor and the input of the reduction stage, red indicates the output of reduction stage with a pulley, and green indicates a planet gear. A sun gear and a ring gear are the innermost and the outermost gears, respectively. A planet carrier is an intermediate gear between them. Gears are represented by vertical stripes, while bearing are represented by X).

To ensure a fair comparison between design concepts, the pulley diameter and the ring gear size were set to be the same and the rated output of motor was set to be similar for all concepts. Then, the location of the motor, gear set and each component was optimally determined for each concept. The diameter of the pulley was fixed at 80 mm. Only motors with a diameter smaller than this pulley diameter were considered. The thickness of the motor was set by referring to commercial motors with similar rated output. For minimizing the diameter of the actuator, only planet gear sets that can be designed within the pulley diameter were considered. The expected weight, height and reduction ratio of each design were used as evaluation variables.

In Design A, the sun gear serves as input and the planet carrier serves as output of the reduction stage. Since the sun gear is an input gear, an inrunner motor was selected. This design features that there are three layers of motor, reduction stage and pulley inside the casing. For coupling with the pulley, the planet carrier is supposed to extend outward from the reduction layer toward the pulley. Since the planet carrier cannot extend toward the motor layer, the pulley itself is supposed to occupy an additional structural layer. This design does not gain any height advantage from the pulley layer. Furthermore, this structure would be relatively heavy due to the weight of the planet carrier.

Design B uses the ring gear as input and the planet carrier as output. Since the ring gear is used as the input, an outrunner motor was selected. Design B is composed of three layers similarly to Design B. This design also needs a separate layer for the pulley due to the same reason. Since the layers were separated, this design also has no height advantage. The use of the ring gear planet carrier and bearing adds weight compared to Design A.

Lastly, Design C uses the sun gear as input and the ring gear as output. Since the sun gear is used as the input, an inrunner motor is employed. In this design, there are two layers. Since the pulley overlaps with the motor layer, there are a motor layer and a reduction layer. The pulley is attached to the ring gear, the motor is placed inside the ring shaped pulley. This placement significantly reduces the height of the actuator due to the eliminated height of the pulley layer that exists in other designs. Since the planet carrier is fixed, it is reduced to a shaft form in the casing. The reduced form of the planet carrier makes the design lighter compared to other designs.

Since a design that uses only a single planet gear set for the reduction stage was considered, the torque requirement also becomes a dominant factor in motor selection. Therefore, the design that allows for a higher gear ratio in the single planet gear set is desirable. The feasible maximum gear ratios of the three design concepts can be compared using Equation 2 to Equation 4. The equation represents the gear reduction ratio for each combination of input and output in the reduction stage.

$${r}_{P / S} = {Z}_{s} / ( {Z}_{R} + {Z}_{S} ) \qquad [ Equation 2 ]$$

$${r}_{P / R} = {Z}_{R} / ( {Z}_{R} + {Z}_{S} ) \qquad [ Equation 3 ]$$

$${r}_{R / S} = - {Z}_{S} / {Z}_{R} \qquad [ Equation 4 ]$$

The gear reduction ratio is denoted by r, and the input and out of the gear reduction stage are indicated by subscripts. S, P and R represent the sun gear, planet carrier and ring gear, respectively. The input is the denominator, and the output is numerator. Z_{S}, Z_{P} and Z_{R} represent the number of teeth on sun, planet and ring gears, respectively. Comparing denominators and numerator on right hand side of three equations, it can be observed that the feasible maximum gear ratio of Design A is the highest for Z_{R} and Z_{P}, followed by design C and design C.

Overall, design C exhibits superior characteristics in terms of actuator height and weight, while ranking second in reduction ratio. It is expected to have a lower height than Design A and Design B. In addition, the gear ratio of Design C increases to approach that of Design A as Z_{S} decreases. In these comparisons, Design C was selected as the optimized design for the new actuator.

### Description of Embodiments

Hereinafter, the configuration of a pulley-integrated cable operator 100 according to an embodiment of the present disclosure will be explained in detail. To design an actuator, after searching the optimum commercial products that meet design requirements, components, such as a motor and an encoder, were selected. Other components, such as a gear and a shaft, were custom-designed to withstand load conditions while meeting design requirements. The actuator components were designed based on their importance.

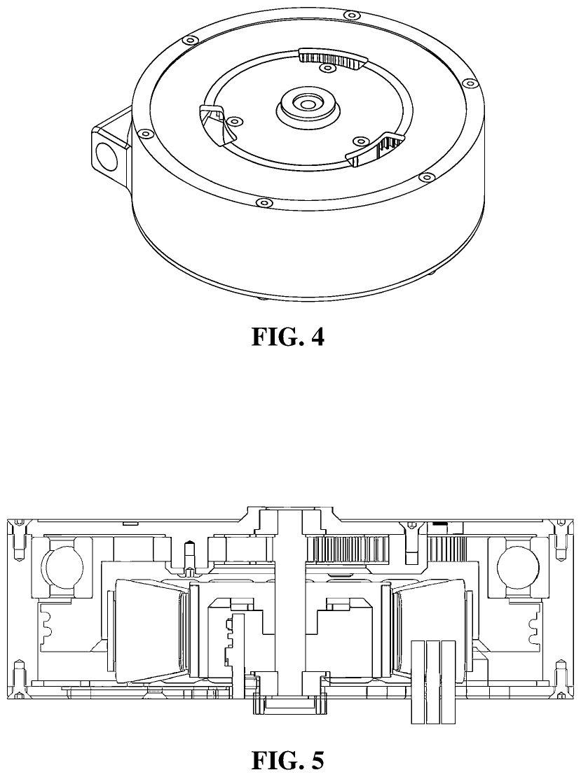

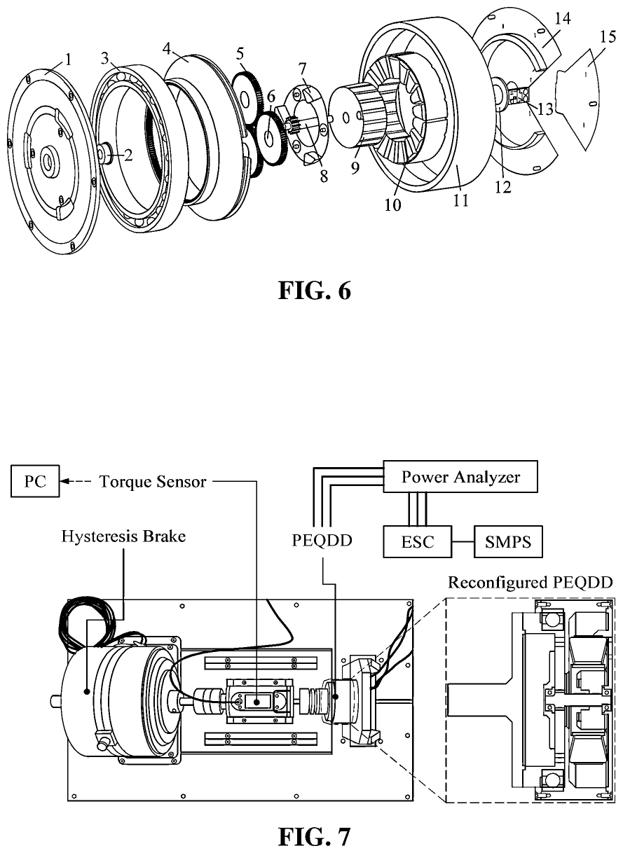

FIG. 4 shows a perspective view of a pulley-integrated cable actuator according to an embodiment of the present disclosure. FIG. 5 show a cross-sectional view of a pulley-integrated cable actuator according to an embodiment of the present disclosure. FIG. 6 shows an exploded perspective view of a pulley-integrated cable actuator according to an embodiment of the present disclosure.

As shown in FIGS. 4 to 6, the pulley-integrated cable actuator includes a base motor, a sun gear shaft 8 of which the lower end portion is coupled to the center of the base motor, rotating by motor rotation and is provided with a sun gear 8-1, a planet gear set consisting of multiple planet gears 5 that mesh with the sun gear 8-1, a ring gear-integrated pulley 4 where a ring gear is formed on the inner side, meshing with the planet gear 5 and a pulley for winding a cable is formed on the outer side.

The base motor is an inner ring rotation type of frameless motor, consisting of a stator 10 and rotor 9. The sun gear shaft 8 is coupled to the center of the rotor 9.

The planet gear set is configured so that the sun gear 8-1 meshes with the inner space formed by the multiple planet gears 5, rotating the respective planet gears through the rotation of the sun gear 8-1. Simultaneously, the outer periphery side meshes with a ring gear formed on the inner side of the ring gear-integrated pulley 4, rotating the ring gear-integrated pulley 4.

The ring gear-integrated pulley 4 is provided with a hollow portion 4-1 and a flange portion 4-2. A ring gear is formed on the inner side of the hollow portion 4-1, and a cable fixing groove 4-3 is provided along the outer periphery of the outer side of the flange portion 4-2 for winding the cable.

A ring gear bearing 3 is inserted and installed into the hollow portion 4-4 of the ring gear-integrated pulley 4.

The base motor, the sun gear shaft 8, the planet gear set, the ring gear-integrated pulley 4 and a sun gear shaft bearing 3 are mounted within the inner space formed by an upper casing 1, a lower casing 14 and an intermediate casing 11.

Further, the pulley-integrated cable actuator includes a planet gear fixing portion 7 that fixes each of planet gear shafts to the upper casing. An encoder is provided inside the rotor, minimizing the volume.

The encoder includes a magnetizing ring 12 coupled to the lower surface of the rotor 9, and a reading head 13 for measuring the rotor rotation speed through the magnetizing ring 12.

In addition, the lower casing 14 includes a cable replacement casing 15 that is configured to enable detachment and attachment to facilitate cable replacement.

The sun gear 8-1 meshes with the inner space of the planet gear set, the ring gear is integrated with a pulley, and the planet gear set is placed inside the pulley to minimize the volume.

As previously mentioned, Design C uses a frameless inrunner motor. Requirement for baseline motor weight, size and performance were set based on design requirements for actuators. To determine the estimated weight of the components, a preliminary draft for actuator's actual design was prepared. The total weight of the components excluding the motor was assumed approximately 440 g. To meet the overall actuator weight requirement of 640 g, the motor weight is supposed to be less than 200 g. To place the motor in the center of the pulley, the outer diameter of the motor is determined by the pulley size. For detailed design considerations, the pulley is supposed to incorporate a socket that accommodates the end tip of the Bowden cable. Therefore, the inner diameter of the pulley needs to be 65 mm and the outer diameter of the motor must not exceed this value.

To prevent actuator height increase, an incremental magnetic encoder device (RLB series, RLS, Slovenia) with a magnetic ring (MR series, RLS, Slovenia) is selected, which can be placed inside the hollow rotor of the motor. Considering the shape of the encoder and a magnetic ring 13, the inner diameter of the rotor 9 must to be 24 mm or higher, allowing for installation of the encoder. The actuator height requirement is 35 mm. Considering the height of the reduction layer and the increase in height from the casing, the height of the motor should not exceed 27 mm. In addition, to place the encoder inside, the height of the rotor 9 must to be 15 mm or higher.

Due to the single-stage reduction, achieving a reduction ratio of 10:1 or more in the detailed design is challenging. Therefore, since the required torque is 13.3 Nm from the pulley, the motor's peak torque should be exceed 1.33 Nm. In addition, to meet the speed requirement of 313 RPM, the motor's is supposed to exceed 320 RPM. Based on the rated torque of 4.76 Nm of the actuation system used in the HE, the required rated torque was set to 0.476 Nm. The overall design requirements for the motor are presented in Table 2.

TABLE 2
Design Requirements for Motor

| Parameter | Design requirement |
|---|---|
| Weight | Weight ≤200 g |
| Shape | Outer diameter of Stator ≤35 mm |
| | Inner diameter of Rotor ≥24 mm |
| | Height of the rotor ≤15 mm |
| | Maximum height of the motor ≤27 mm |
| Performance | Rated torque ≥0.476 N-m |
| | Peak torque ≥1.22 N-m |
| | Speed ≥3130 RPM |

Motors from four manufactures (T-MOTOR from China, Allied Motion from the United States, Celera MOTION from the United States, and WITTENSTEIN from Germany) were compared. Table 3 presents the specifications for each motor with the requirements. RI60KV120 of T-MOTOR was selected as a baseline motor among all the compared motors.

TABLE 3
List of Commercially Available Frameless Motors, Optimally Selected

| | | Basic dimension of motor (mm) | | | | | | | Torque | | |
|---|---|---|---|---|---|---|---|---|---|---|---|
| | | Stator | | | Rotor | | | Weight | (N-m) | | |
| Company | Product | O.D | I.D | H | O.D | I.D | H | (g) | Rated | Peak | RPM |
| t-motor | RI50 | 54 | 29.6 | 24 | 28.6 | 22 | 19 | 180.8 | 0.58 | 1.67 | 4500 |
| | KV100 | | | | | | | | | | |
| t-motor | RI50 | 60 | 37 | 21 | 35.8 | 30 | 15 | 155.9 | 0.57 | 1.63 | 5600 |
| | KV120 | | | | | | | | | | |
| celera motion | OPN- | 60 | 41.7 | 21.89 | 40.6 | 31 | 17.5 | 190 | 0.584 | 1.26 | 5504 |
| | 060-013 | | | | | | | | | | |
| celera motion | UTH-63 | 63.5 | 29.16 | 25.4 | 28.34 | 12.68 | 15.27 | 274 | 0.53 | 1.61 | 3453 |
| allied motion | MF- | 60 | 36 | 7.62 | N/A | 36.195 | 12.7 | 130 | 0.29 | 2.3 | 4456 |
| | 0060008 | | | | | | | | | | |
| allied motion | MF- | 60 | 36 | 29.86 | N/A | 36.195 | 24.6 | 270 | 0.54 | 5.3 | 3382 |
| | 0060020 | | | | | | | | | | |
| WITTENSTEIN | 050-101 | 50 | 38.2 | 23.2 | N/A | 30 | 15.8 | 81 | 0.36 | 0.8 | 6959 |

(Values that exceed the motor selection constraints are shown in black (O.D: Outer Diameter, ID: Inner Diameter, H: Height))

The selected design concept of planet gear set utilizing a sun gear as input and a ring gear as output, is designed to meet the desired torque requirements of the actuator. The selected motor has a peak torque of 1.63 Nm, and a gear reduction of 8.16:1 or higher is required to meet the actuator's torque requirement of 13.3 Nm.

The reduction ratio of the planet gear can me calculated by Equation 4, where the subtraction symbol indicates a change in direction between the input and output. The basic equations for the number of teeth on each gear in the planet gear set are represented by following equations 5 to 7.

$${Z}_{R} = {Z}_{S} + 2 {Z}_{P} \qquad [ Equation 5 ]$$

$$\frac{{Z}_{S} + {Z}_{R}}{N} = integer \qquad [ Equation 6 ]$$

$${Z}_{P} + 2 < ( {Z}_{S} + {Z}_{P} ) sin ( \frac{180 °}{N} ) \qquad [ Equation 7 ]$$

where N is the number of planet gears.

In Equation 4, the reduction ratio should be maximized by minimizing Z_{S}. In an embodiment of the present disclosure, Z_{S} was set to 14 (the minimum number of teeth to prevent undercutting at a pressure angle of 20 degrees). To meet gear reduction requirements, Z_{R} should be greater than 114. In addition, Z_{R} should be less than 130 to ensure it diameter is smaller than the pulley's inner diameter (65 mm, including a 0.5 gear for stable operation). A value of 118 was selected for Z_{R}, ensuring a robust structure while meeting all the constraints. Using the Z_{S} and Z_{R} set, equations 6 and 7 can only be satisfied when N is either 2 or 3. To minimize the load conditions on the planet shaft and gears, N was set to 3.

The reduction ratio of the designed planet gear set is 8.428:1. The calculated rated torque, peak torque and speed using the gear ratio were 4.8 Nm, 13.7 Nm, and 664 RPM, respectively, meeting the design requirements. The detailed design process for each gear was carried out using CAD (Inventor 2022, Autodesk, USA). To minimize the height of the actuator, the gear set was designed to prevent mechanical malfunctioning due to material characteristics while minimizing gear width, leading to the use of 4 mm wide gears. Table 4 presents the specifications for the reduction stage.

TABLE 4
Planet Gear Set Specification

| Parameter | Value |
|---|---|
| Z_{S} | 14 |
| Z_{P} | 52 |
| Z_{R} | 118 |
| N | 3 |
| Module size (mm) | 0.5 |
| Pressure angle (deg) | 20 |
| Thickness of the gear (mm) | 4 |
| Material of Sun Planet gear | SCM415 |
| Material of Ring gear | A1707T5-T6 |

Further, to prevent mechanical defects, the shafts of the sun and planet gears were analyzed in terms of their strength and stiffness. Since the sun gear and shaft were designed as a single unit, SCM415 was used as the material for the sun gear shaft, just as it was for the sun gear. Since the planet gear shaft was designed for direct connection with the casing directly, Al4075-T6 was used to reduce the overall weight of the actuator.

When calculating the minimum allowable shaft diameter in terms of material strength, A safety factor of 3 was used considering extreme load conditions. The sun gear shaft was analyzed considering the influence of a key insertion notch, and the planet gear shaft was designed considering the properties of the ductile material (Al7075-T6). The required shaft diameter was calculated by following Equations 8 to 9.

$$σ = {K}_{f} \frac{32 M}{π {d}^{3}} \qquad [ Equation 8 ]$$

$$τ = {K}_{fs} \frac{16 T}{π {d}^{3}} \qquad [ Equation 9 ]$$

In the above Equations, σ and τ represent the tensile and shear strength of the material, respectively. M represents the bending stress, T represents the torque. K_{f} and K_{fs} represent the fatigue stress-concentration factors for bending and torsion, respectively. For the sun gear shaft, the minimum required diameter of 4.7 mm was obtained using Equation 9 with a K_{fs} value of 4.43. Since the planet gear shaft does not have a notch, a value of 1 was used in the Equation to obtain the required planet gear shaft diameter of 5.27 mm. Therefore, the sun gear shaft and planet gear shaft were designed with diameters of 5 mm and 6 mm, respectively, to meet the minimum allowable diameters.

The selection of bearings has the most significant impact on the actuator operational stability. Minimizing the clearance between the bearing's inner diameter and the shaft's outer diameter leads to minimization of noise and vibration during operation. For designing an exosuit actuator that comes into direct contact with the user, it is crucial to minimize noise and vibration from the actuator. Therefore, top-grade bearings were selected with consideration of the operating conditions for each rotating component.

The sun gear shaft, which is directly connected to the rotor, maintains a constant interval between the rotor and the stator. Therefore, ABEC5 grade bearings (7804K129, McMaster-Carr, USA) were employed at both ends of the sun gear. Considering that the planet gear shaft is shorter than the sun gear shaft and the speed of the planet gear is slower than the sun gear, ABEC3 grade bearings (57155K587, McMaster-Carr, USA) were used. ABECO grade bearings (813ZZ, NSK, Japan) were employed to the ring gear and pulley, which have the largest supporting area compared to other components.

In an embodiment of the present disclosure, a prototype of the aforementioned pulley-integrated cable actuator was fabricated and its performance was evaluated.

That is, utilizing the aforementioned selected components, a pulley-integrated QDD actuator (PEQDD) was fabricated, as shown in FIGS. 4 to 6. The diameter, thickness, volume and mass of the actuator were 93 mm, 31.5 mm. 203 cm and 590 g, respectively.

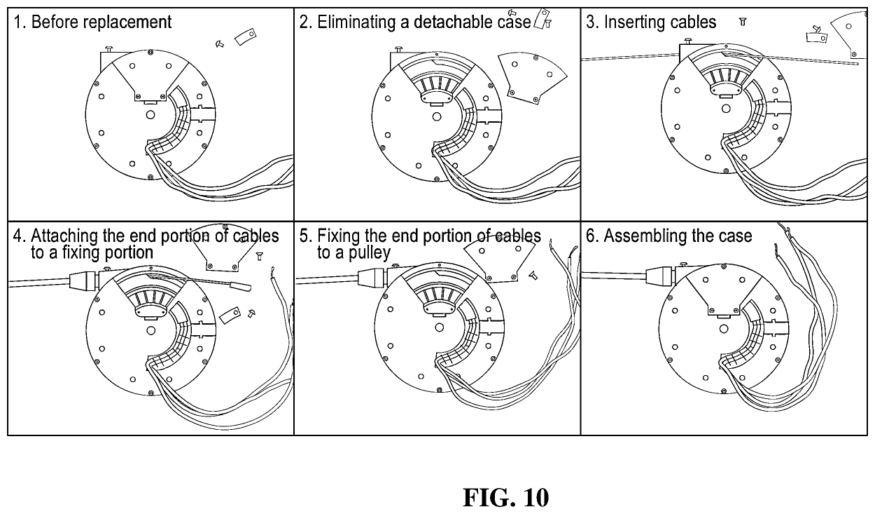

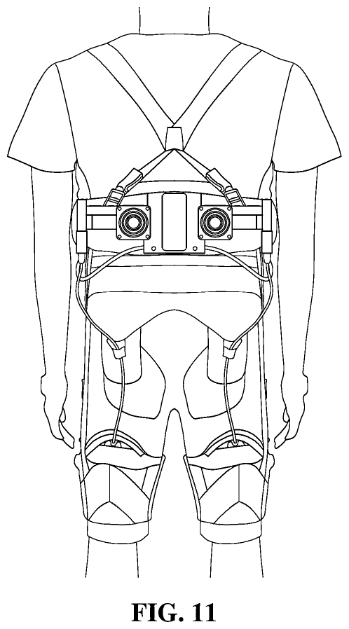

The pulley and ring gear were integrated into a single component, and the bearing 3 supporting this component is located on the outside of the planet gear set. To efficiently replace Bowden cable without dissembling the actuator, the lower casing 14 was designed to be easily detached (Cable replacement casing 15). FIG. 10 shows a flowchart of the cable replacement according to an embodiment of the present disclosure. To minimize the deformation of the planet gear shaft while the planet gear is fixed and subjected to load, a component was added to fix the shaft. The sun gear and planet gear were subjected to nitriding treatment to increase the gear's surface hardness, and the casing was anodized to prevent corrosion.

Performance testing under diverse conditions is necessary during the development of actuators. The absence of this information renders the actuator unreliable for designing products that must meet specific requirements under diverse conditions. In addition, unawareness of an actuator's efficiency leads to inefficient use. The performance and characteristics of the PEQDD actuator were evaluated through tests. Additionally, an exosuit designed for PEQDD operation was fabricated. Its operating device was then compared to the HE operation system.

### A. Performance Evaluation: Steady-State Condition

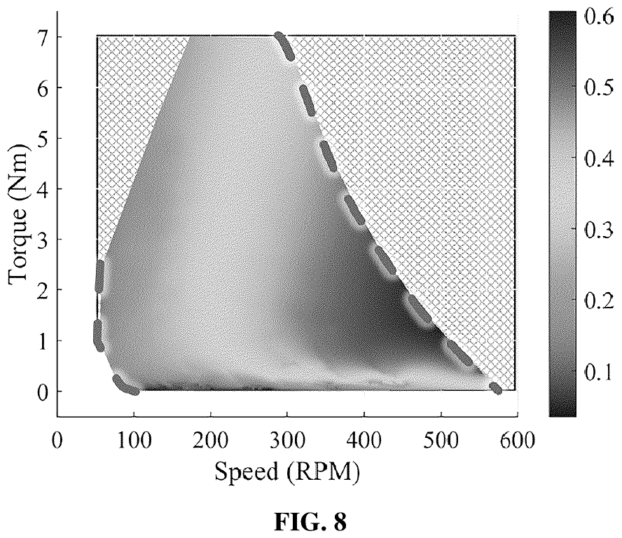

Representative parameters in under steady-state conditions are torque, speed and energy efficiency. Efficiency is one of the important characteristics of an actuator and defined as the ratio of mechanical energy output to electrical energy input. Testing efficiency under various speeds and load conditions can demonstrate the robustness of the actuator. The steady-state performance of PEQDD was measured using a dynamometer with the setups described in FIGS. 7 and 8. FIG. 7 shows the Dynamometer test setup for evaluating the steady-state performance of PEQDD. FIG. 8 shows an energy efficiency map of PEQDD under the steady-state condition (Areas marked in red indicate operating ranges that fall outside the normal range).

The used dynamometers in the test consisted of a rotary torque sensor (M425, Datum, UK) for measuring torque and rotational speed and a hysteresis brake (AHB-24, Valid Magnetics, Hong Kong) for applying a constant load to the actuator. In an embodiment of the present disclosure, power was supplied to the actuator using electronic speed controller (ESC; FLAME 100A 14S, T-MOTOR, China) together with a switching mode power supply (E-1500-48, MEANWELL, Taiwan). To measure input power supplied to the actuator, a power analyzer (WT-1804e, Yokogawa Electric, Japan) was placed between the ESC and actuator. Since the actuator design with the pulley facing downwards toward the motor direction was not suitable for connecting to the dynamometer, the configuration of the actuator was modified as shown in FIG. 7. The pulley was placed to face upwards by reversing the direction of the pulley without changing components of the gear transmission. The upper casing 1 that secures the planet gear in place was replaced beneath the reduction stage, and additional components were used to connect the pulley to the dynamometer.

The test conditions varied the motor's input voltage and the load applied to the actuator from the break. The input voltage was applied in 3V increments from 18V to 18V across the conditions. For each voltage condition, torque was applied to the pulley while maintaining a constant voltage using a hysteresis break. Torque was increased starting from zero load conditions to the point where either the stall point was reached or motor temperature exceeded 150° C. under each voltage condition. Temperatures above this point may causes permanent damage to the motor. Load conditions above this point have not been tested and are considered as conditions outside the normal operation range. The amount of torque generated in the hysteresis break was controlled by the input current of the break, which was set in 25 mA increments for each condition. The motor temperature for each condition was cooled down to 25° C. before staring the test.

The efficiency for each condition was calculated using Equations 10 to 12 with data obtained for 5 seconds after applying load.

$$efficiency η = \frac{{P}_{Out}}{{P}_{In}} \qquad [ Equation 10 ]$$

$${P}_{In} = V \cdot I \qquad [ Equation 11 ]$$

$${P}_{Out} = T \cdot ω \qquad [ Equation 12 ]$$

P_{In} and P_{Out} represent input voltage and output voltage, respectively. P_{In} was calculated from the input voltage (V) and current (I) and measured by power analyzer. P_{Out} was calculated using the input torque obtained from the torque sensor T and actuator speed data @.

FIG. 8 shows an energy efficiency map from the test point. Data was analyzed using MATLAB (R2021b, Mathworks, USA). A low-pass filter with a cutoff frequency of 1 Hz was applied to the data obtained from the power analyzer and torque sensor. An additional median filter with a window size of 100 was applied to the calculated efficiency to remove remaining noise, providing a better representation of steady-state results. The map was plotted using natural neighbor interpolation with normalized data from all test conditions.

In FIG. 8, the blue and red dashed lines represent data for the conditions with input voltages of 18V and 48 W, respectively. Based on test results, the efficiency of the PEQDD actuator ranges from 0 to 0.605, and increases with increasing input voltage. At a specific operation speed, the efficiency increased with increasing load from zero to 1.5 Nm and then gradually decreased as the load continued to increase. Regardless of input voltage, the maximum efficiency was achieved under a load condition of 1.5 Nm. The absence of any critical power transmission flaws in the PEQDD design was confirmed through this steady-state performance analysis.

### B. Performance Evaluation: Bandwidth Control

An exosuit controller according to an embodiment of the present disclosure employed admittance control for force control, achieving position control. This admittance control acts as a lower-level controller. Consequently, improved admittance control and force control can be expected due to the enhancement on the control bandwidth of position control.

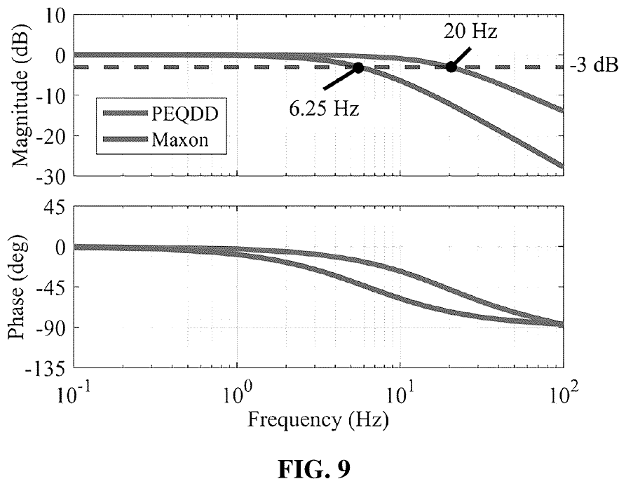

The control bandwidth of the actuators used in PEQDD and HE were compared that of the position closed-loop condition using a tuning program (Elmo Application Studio II, Elmo Motion Control Ltd, Israel) and a motor controller (Gold Solo Twitter R50/100, Elmo Motion Control Ltd, Israel). Using the built-in automatic identification tool of the tuning program, 100% continuous current was applied to the two actuators under zero load conditions. A motion was generated to rotate the pulley one revolution using frequencies between 0.1 and 100 Hz. As shown in FIG. 9, the cutoff frequency of PEQDD was 20 Hz while that of Maxon was 6.25 Hz. An increase in the cutoff frequency can be expected to lead to an increase in the controllability of the force controller. This improvement of control performance will better compensate for the force transmission between the operating system and the human body.

### C. Preliminary Test: Exosuit Implementation

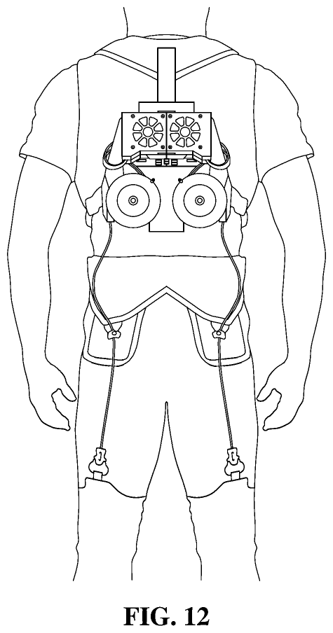

Preliminary tests were conducted to evaluate the performance of the PEQDD integrated into the exosuit under actual walking and running conditions. For the test, a new version of a hip exosuit was developed utilizing PEQDD as shown in FIG. 12.

A preliminary test was conducted on a healthy male subject (Age: 27, Height: 1.76 cm, Weight: 69.4 kg) to validate the performance of PEQDD. The subject walked and ran for two minutes at speeds of 1.4 m/s and 2.1 m/s, respectively. Since the test was preliminary, the force profile range was set between 200 and 250N, lower than the maximum performance of PEQDD, to ensure the safety of both the subject and the operating system. Load data was sampled at 1 kHz using a load cell (LSB205, Futek, USA) and a real-time controller (CompactRio9040, National Instruments, USA) and filtered using a low-pass filter with a cutoff frequency of 20 Hz.

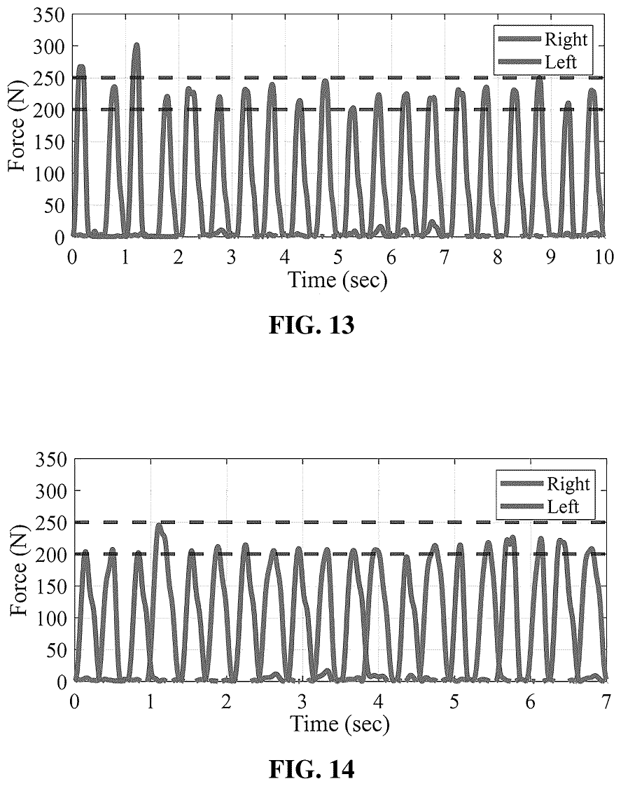

FIGS. 13 and 14 show 10 seconds of data from 2 minute measurement data during walking and running, respectively. As shown in FIGS. 13 and 14, the maximum force remained mostly stable within the target range. During walking, the maximum force of the left and right legs were 232±3.47 and 235±9.28 N (mean±Standard Error of the Mean: SEM), respectively. During running, the peak force of the left and right legs were 215±3.90 and 210±2.98 N (mean±SEM), respectively. During walking, intermittent peak forces exceeding 300 N were transmitted in some strides. Based on this, it can be indirectly inferred that PEQDD can transmit forces exceeding the 300N design requirement. The maximum pulley rotation speeds under walking and running conditions were 301 RPM and 341 RPM, respectively.

The PEQDD according to an embodiment of the present disclosure is a new actuator based on quasi-direct actuation with an embedded pulley. This actuator is smaller and lighter, and has higher control bandwidth compared to cable-driven actuation systems in state-of the-art HE. To select the optimal actuator design for an exosuit, various actuator design concepts were evaluated. The fabricated PEQDD has a diameter of 93 mm, a thickness of 31.5 cm, a volume of 203 cm³ and a mass of 590 g.

The performance of the PEQDD was evaluated through various tests. The efficiency of the PEQDD was evaluated under steady-state conditions using dynamometer. The maximum efficiency of the PEQDD was 0.605. The control bandwidth of the actuator was evaluated under position closed-loop conditions. The cutoff frequency of the PEQDD was 20 Hz and the cutoff frequency of the Maxon motor used in the Harvard exosuit was 6.25 Hz. Pre-tests were conducted using a hip extension exosuit that utilizes the PEQDD. The results showed that the PEQDD met all design requirements.

1. As an actuator for operating cables, a pulley-integrated cable actuator comprising:
a base motor;
a sun gear shaft of which the lower end portion is coupled to the center of the base motor, rotating by the motor rotation, and provided with a sun gear;
a planet gear set consisting of multiple planet gears that mesh with the sun gear; and
a ring gear-integrated pulley where a ring gear is formed on the inner side, meshing with the planet gear, and a pulley for winding a cable is formed on the outer side.

2. The pulley-integrated cable actuator of claim 1, wherein
the base motor is an inner ring rotation type of frameless motor, consisting of a stator and a rotor, and the sun gear shaft is couple to the center of the rotor.

3. The pulley-integrated cable actuator of claim 2, wherein
the planet gear set is configured so that the sun gear meshes with the inner space formed by meshing of the multiple planet gears, rotating the respective planet gears through the sun gear rotation. Simultaneously, the outer periphery side meshes with a ring gear formed on the inner side of the ring gear-integrated pulley, rotating the ring gear-integrated pulley.

4. The pulley-integrated cable actuator of claim 3, wherein
the ring gear-integrated pulley comprises a hollow portion and a flange portion. A ring gear is formed on the inner side of the hollow portion and a cable fixing groove is provided along the outer periphery of the outer side of the flange portion for winding the cable.

5. The pulley-integrated cable actuator of claim 4, further comprising
a ring gear bearing inserted into the hollow portion of the ring gear-integrated pulley.

6. The pulley-integrated cable actuator of claim 5, wherein
the base motor, the gear shaft, the planet gear set, the ring gear-integrated pulley and a sun gear shaft bearing are mounted within the inner space formed by an upper casing, a lower casing and an intermediate casing.

7. The pulley-integrated cable actuator of claim 6, further comprising
a planet gear fixing portion that fixes each of planet gear shafts to the upper casing.

8. The pulley-integrated cable actuator of claim 7, further comprising
an encoder provided inside the rotor.

9. The pulley-integrated cable actuator of claim 8, wherein
the encoder comprises a magnetizing ring coupled to the lower surface of the rotor, and a reading head for measuring the rotor rotation speed through the magnetizing ring.

10. The pulley-integrated cable actuator of claim 6, wherein
the lower casing comprises a cable replacement casing that is configured to enable detachment and attachment to facilitate cable replacement.

11. The pulley-integrated cable actuator of claim 5, wherein
the sun gear meshes with the inner space of the planet gear set, the ring gear is integrated with a pulley, and the planet gear set is placed inside the pulley to minimize the volume.

12. An operation method of a pulley-integrated cable actuator according to claim 1, comprising steps of:
rotating a rotor of a base motor;
rotating a sun gear coupled to a rotor center shaft, rotating each planet gear meshed with the sun gear; and
rotating a ring gear-integrated pulley by the planet gear rotation to drive cables wound around the ring gear-integrated pulley.
